(19) United States
(12) Patent Application Publication
(10) Pub. No.: US 2010/0064857 A1
(43) Pub. Date: Mar. 18, 2010

(54) COAXIAL CABLE END PREPARATION TOOL AND RELATED METHODS

(75) Inventor: Ronald A. Vaccaro, Hickory, NC (US)

Correspondence Address: Allen Dyer Doppelt Milbrath & Gilchrist;(Commscope), 255 S. Orange Avenue, Suite 1401, Orlando, FL, 32801, US

(73) Assignee: CommScope, Inc. of North Carolina, Hickory, NC (US)

(21) Appl. No.: 12/210,512

(22) Filed: Sep. 15, 2008

(51) Int. Cl. H01R 43/04; H02G 1/12

(52) U.S. Cl. 81/9.4; 29/867

(57) ABSTRACT

A cable end preparation tool for a coaxial cable may include a body having first and second opposing ends with a first recess in the first end, and a first blade carried by the body within the first recess for stripping an outer jacket of the cable to expose a portion of an outer conductor when the body is rotated relative to the cable. A second blade may be carried by the body within the first recess for stripping the outer conductor and a dielectric layer to expose a portion of an inner conductor when the body is rotated relative to the cable. The tool may further include a coring bit carried by the second end of the body for removing a portion of the dielectric layer between the inner conductor and the exposed portion of the outer conductor when the body is rotated relative to the coaxial cable.

### FIELD OF THE INVENTION

The present invention relates to the field of cables and connectors, and, more particularly, to coaxial cable end preparation tools and related methods.

### BACKGROUND OF THE INVENTION

Coaxial cable is an electrical cable that includes an inner conductor surrounded by an insulating dielectric layer or spacer, which is in turn surrounded by an outer cylindrical conductor. A protective outer jacket typically surrounds the outer conductor. A coaxial cable provides protection of signals from external electromagnetic interference, and effectively guides signals with low emission along the length of the cable.

One particular application for coaxial cables is in cellular base station or tower installations. Large, industrial grade coaxial cables and connectors are used to connect the telephone network communication equipment located at the bottom of the cell tower with the antenna array positioned at the top of the tower. In a typical cell tower installation, there are usually at least a dozen connectors that are required, and in larger installations several dozen connectors are not uncommon.

Installation of coaxial cable connectors requires that a technician cut and prepare the coaxial cable ends at the appropriate location to mount the connector thereon. In particular, the cable end preparation requires removal of the outer jacket to expose a portion of the outer conductor, as well as removal of the outer conductor and dielectric layer to expose a portion of the inner conductor. Moreover, the exposed portion of the outer conductor may also require flaring. However, performing these operations can be difficult given the diameter of commercial grade coaxial cable, and the use of knives or other basic cutting tools with exposed blades causes a significant risk of injury to the technician. Moreover, a technician may be required to install connectors while at the top a cell tower, which compounds the difficulties of preparing a cable end with basic cutting tools.

As a result, various cable preparation tools have been developed to make coaxial cable end preparation easier for installation technicians. One such example is set forth in U.S. Pat. No. 6,668,459 to Henningsen. This patent describes stripping tools for coaxial cables with a corrugated outer conductor and a hollow inner conductor. The tool includes three main parts: a jacket cutting part for removing a certain predetermined length of the jacket of the cable, a guide part to be placed around the end of the cable after the jacket has been removed by the jacket cutting part, and a second cutting part to be placed on the guide part during a final preparation of the end of the cable during which the inner conductor, the outer conductor and the dielectric material between inner and outer conductor are cut to appropriate lengths. The guide part is provided with a portion for determining a well-defined longitudinal position of the tool on the cable relative to the pattern of valleys and crests of the corrugation on the outer conductor.

An exemplary cable flaring tool is described in U.S. Pat. No. 7,059,162 to Tarpill et al. The flaring tool is for flaring the outer conductors of two different sizes of coaxial cable, and it includes a dome-shaped body and a reversible tool head. The tool head has first and second shafts and first and second flaring heads on opposite sides. Reversing the tool head exposes the shaft and flaring head for the corresponding size of coaxial cable. The shafts match the inner diameter of the inner conductor of the coaxial cable to be flared. The flaring heads are shaped as half cones, which allow the outer conductor to be flared without deforming the insulation between the inner and outer conductors of the coaxial cable.

Despite the existence of such stripping and flaring tools, further advancements in coaxial cable end preparation tools and methods may be desirable. For example, tools such as those noted above may only be compatible with a particular type of coaxial cable, such as those with a corrugated outer conductor or those with a straight (i.e., non-corrugated) outer conductor. Moreover, tools that can be used either with or without the assistance of a power driver, such as a cordless drill, may also be helpful to technicians.

### SUMMARY OF THE INVENTION

In view of the foregoing background, it is therefore an object of the present invention to provide a cable end preparation tool for coaxial cables and related methods.

This and other objects, features, and advantages are provided by a cable end preparation tool for a coaxial cable including an inner conductor, a dielectric layer surrounding the inner conductor, an outer conductor surrounding the dielectric layer, and an outer jacket surrounding the outer conductor. The cable end preparation tool may include a body having first and second opposing ends with a first recess in the first end thereof, and a first blade carried by the body and extending within the first recess for stripping the outer jacket to expose a portion of the outer conductor when the body is rotated relative to the coaxial cable. A second blade may be carried by the body and also extend within the first recess for stripping the outer conductor and dielectric layer to expose a portion of the inner conductor when the body is rotated relative to the coaxial cable. The tool may further include a coring bit carried by the second end of the body for removing a portion of the dielectric layer between the inner conductor and the exposed portion of the outer conductor when the body is rotated relative to the coaxial cable.

More particularly, the coring bit may have a predetermined shape for flaring the exposed portion of the outer conductor when the body is rotated relative to the coaxial cable. In addition, the coring bit may include a cutting head with a central opening therein for receiving the exposed inner conductor. Also, the body may further have a coring bit recess therein for receiving the coring bit. By way of example, the coring bit and the coring bit recess may be rectangular. The body may also have a second recess in the second end thereof, and the coring bit recess may be within the second recess.

Furthermore, the coring bit may have marking indicia thereon, and the body may have an indicia reading opening therein aligned with the marking indicia. The first and second blades may also be removably mounted to the body. Additionally, the body may have a plurality of surface gripping features on an external surface thereof. The body may have a cylindrical shape, and it may also comprise plastic, for example.

In addition, the body may have a longitudinal center axis and at least one hole therethrough perpendicular to the longitudinal center axis. Further, the body may have a visual indicator on an exterior surface thereof corresponding to a longitudinal spacing between the first and second blades.

A cable end preparation method for a coaxial cable may include providing a cable end preparation tool, such as the one described briefly above, and positioning the coaxial cable in the first recess and rotating the body relative to the coaxial cable to strip the outer jacket to expose a portion of the outer conductor using the first blade and to strip the outer conductor and dielectric layer to expose a portion of the inner conductor using the second blade. The method may further include positioning the coring bit on the coaxial cable and rotating the body relative to the coaxial cable so that the coring bit removes a portion of the dielectric layer between the inner conductor and the exposed portion of the outer conductor.

### BRIEF DESCRIPTION OF THE DRAWINGS

FIG. 1 is a side view of a cable end preparation tool in accordance with the invention.

FIG. 2 is a perspective view of the tool of FIG. 1.

FIG. 3 is a perspective view of corrugated and non-corrugated coaxial cables with exposed inner and outer conductor portions after preparation with the tool of FIG. 1.

FIG. 4 is an end view of the tool of FIG. 1 showing a coring bit thereof.

FIG. 5 is an end view of the tool of FIG. 4 with the coring bit removed to show a coring bit recess.

FIG. 6 is a top perspective view of an alternative embodiment of the tool of FIG. 1 including a coring bit with a drive shaft and cutting head.

FIGS. 7 and 8 are side views of the coring bit of FIG. 6 before and after connection of the removable drive shaft to the cutting head, respectively.

FIGS. 9 and 10 are flow diagrams illustrating method aspects of the using the cable end preparation tools of FIGS. 1 and 6, respectively.

FIG. 11 is a side view of an alternative embodiment of the cable end preparation tool of FIG. 1.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

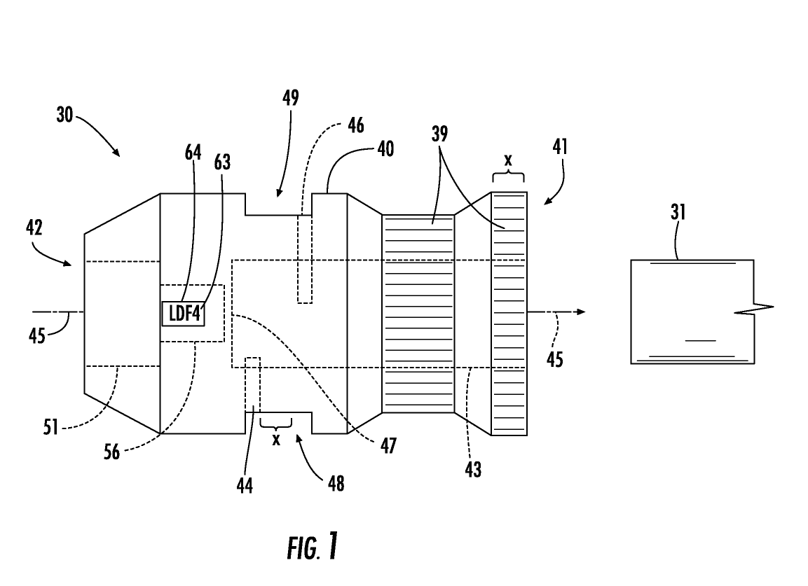

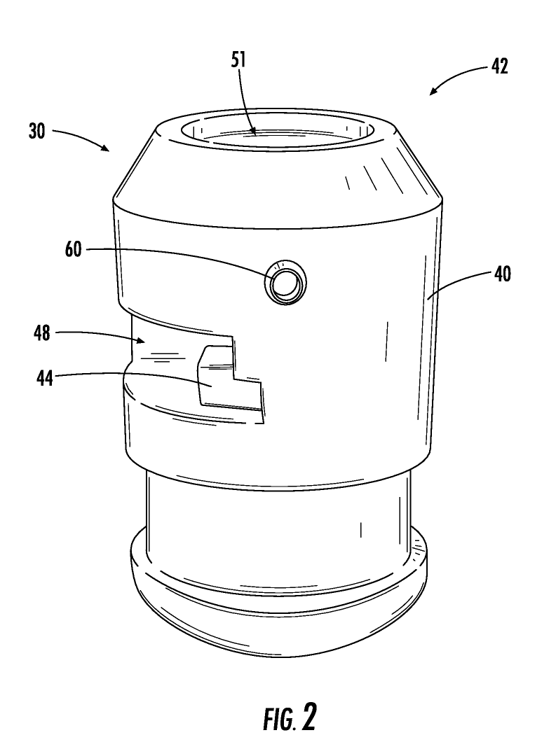

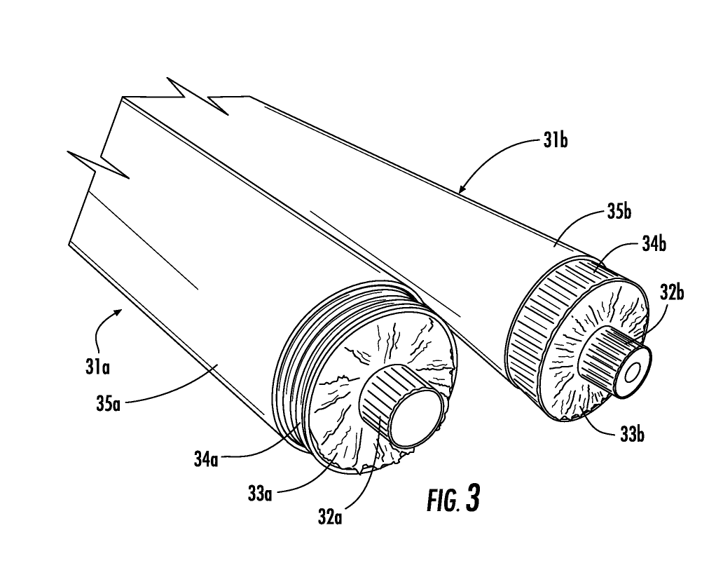

Referring initially to FIGS. 1-5, a cable end preparation tool 30 for a coaxial cable 31 is first described. Two main types of industrial coaxial cables are typically used in applications such as cellular tower installations, for example, which include a corrugated coaxial cable 31a and non-corrugated or smooth wall coaxial cable 31b (FIG. 3). The coaxial cables 31a, 31b respectively include an inner conductor 32a, 32b, a dielectric layer 33a, 33b surrounding the inner conductor, an outer conductor 34a, 34b surrounding the dielectric layer, and an outer jacket 35a, 35b surrounding the outer conductor. The difference between the two cables 31a, 31b is that the outer conductor 34a is corrugated, while the outer conductor 34b is not. By way of example, typical sizes of coaxial cables for telecommunications applications include ½ inch, ⅞ inch, 1¼ inch, and 1⅝ inch, and the tool 31 may be sized for use with these and other sizes of cables.

Reference herein to any of the foregoing coaxial cable components without an “a” or “b” suffix means that the tool 30 may be used with either. For example, when it is said that the tool 30 strips the outer jacket 35 from the outer conductor 34, this means that either the outer jacket 35a or 35b can be stripped from the outer conductor 34a or 34b using the tool, depending upon which type of cable is being used in the given installation. Also, while the tool 30 is described herein by way of example for use with cellular tower cable installations, it will be appreciated that the tool may be used for cable end preparation in other applications as well.

The cable end preparation tool 30 illustratively includes a body 40 having first and second opposing ends 41, 42. In the illustrated example the body 40 is cylindrical, but other body shapes may also be used in different embodiments. The body 40 may be made from a variety of materials, such as metal, wood, and plastic, for example, using common manufacturing techniques known to those skilled in the art. The body 40 further illustratively includes a plurality of raised surface gripping features 39 thereon (knurls in the illustrated embodiment) to help facilitate gripping by the user, although a variety of textured surfaces or other gripping features (e.g., dimples, grooves, etc.) may also be used, if desired, but gripping features are not required in all embodiments. The second end 42 is tapered in the exemplary embodiment, but it need not be tapered in all embodiments.

A first recess 43 is in the first end 41 of the body 40, and a first blade 44 is carried by the body and extends within the first recess 43 for stripping the outer jacket 35 to expose a portion of the outer conductor 34 when the body is rotated relative to the coaxial cable 31. By way of example, the first recess 43 may be sized according to the diameter of the coaxial cable 31. That is, the first recess 43 may have a diameter that is slightly larger than the diameter of the cable 31. When the technician places the cable 31 within the first recess 43, he may then rotate the body 40 about a longitudinal center axis 45 thereof while also pushing the body toward the cable, which causes the first blade 44 to strip or cut the outer jacket off of the outer conductor 34, as seen in FIG. 3.

A second blade 46 is illustratively carried by the body 40 and also extends within the first recess 43 for stripping the outer conductor 34 and dielectric layer 33 to expose a portion of the inner conductor 32 when the body is rotated relative to the coaxial cable 31. The exposed portion of the inner conductor 32 extends outwardly beyond the exposed portion of the outer conductor 34 as shown perhaps best in FIG. 3. Again, the stripping occurs when the user rotates the body 40 by hand and pushes the body toward the cable 31. The user pushes and rotates the body 40 until the exposed portion of the inner conductor 32 contacts a bottom 47 of the first recess 43. That is, the bottom 47 and first blade 44 may be set at the proper spacing so that the bottom provides a stop to make the exposed outer conductor 34 portion the desired length for the given coaxial connector to be connected to the cable 31. Likewise, the second blade 46 may also be set relative longitudinally to the first blade 44 to provide the appropriate length for the exposed inner conductor portion 32.

In accordance with another advantageous aspect, an exterior surface portion of the tool 30 may also provide or have a visual guide or indicator thereon to indicate to the technician when the proper stripping depth for the cable 31 has been reached. More particularly, a lip or rim 65 of the first end 41 is illustratively set to a width x, which is the same width as the longitudinal spacing or distance between the first and second blades 44, 46. In other words, when the cable 31 bottoms out in the first recess 43, the width of the exposed inner conductor 32 will be equal to the width of the lip 65. Thus, the technician can simply remove the cable 31 from the first recess 43 and position the exposed inner conductor 32 next to the lip 65 to see if they are the same width, meaning that stripping is complete.

It should be noted that the first and second blades 44, 46 need not necessarily strip all of the outer jacket 35 and dielectric layer 33 from the outer conductor 34 and inner conductor 32, respectively, in all embodiments. That is, a small or residual amount of jacket and/or dielectric material may remain on the outer/inner conductors 34, 32, which typically may be cleaned off by hand or which may be small enough not to interfere with connector attachment/conductivity. The body 40 also illustratively includes first and second blade access openings 48, 49 for the first and second blades 44, 46, respectively, which not only allow cuttings to exit the first recess 43, but also allow the first and second blades to be removed and/or replaced in certain embodiments, if desired.

The tool 30 also illustratively includes a coring bit 50 carried by the second end 42 of the body 40 for removing a portion of the dielectric layer 33 between the inner conductor 32 and the exposed portion of the outer conductor 34 when the body is rotated relative to the coaxial cable 31. In the illustrated embodiment, the coring bit 50 is carried within a second recess 51 in the second end 42 of the body 40. Like the first recess 41, the second recess 51 is sized according to the coaxial cable size and provides a guide for insertion and steadying the tool 30 on the cable end so that the user may again push the body 40 toward the cable 31 and rotate or twist it about the central axis 45. This also keeps the coring bit 50 recessed within the body 40 so that it does not accidentally scrape other objects or the technician. However, the coring bit 50 need not be recessed within the body 40 in all embodiments.

The coring bit 50 illustratively includes a cutting head 52 comprising teeth 53 for removing the dielectric material 33 as the bit is rotated, similar to a drill bit. The teeth 53 are also tapered on their sides 54 which, as the teeth progress inside the outer conductor 34, cause the outer conductor to flare outwardly, as will be appreciated by those skilled in the art. A back nut connector (not shown), which is used to screw the prepared cable end to a corresponding coaxial plug, etc., is typically placed on the cable 31 after stripping and before flaring with the coring bit 50, as will be appreciated by those skilled in the art. The tapered sides 54 flatten out to a stopping point as shown so that the cutting head 52 will stop progressing once the appropriate flaring and depth have been achieved. However, it should be noted that flaring may not be required in certain implementations depending upon the given cable and connector type, and thus in such applications the tapered sides 54 would not be required, as will also be appreciated by the skilled artisan.

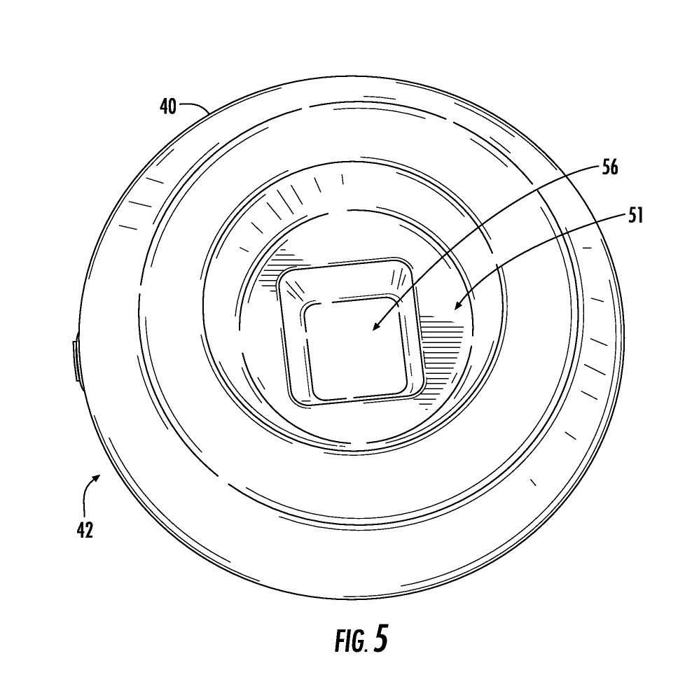

The cutting head 52 also has a central opening 55 therein for receiving the exposed inner conductor 32. The central opening 55 therefore provides a guide for insertion of the exposed inner conductor 32 into the cutting head 52, and thereby helps align the cutting head for removal of the dielectric layer 33 and flaring of the outer conductor 34. In the illustrated embodiment, the body 40 also has a coring bit recess 56 within the second recess 51 for receiving the coring bit 50, which is centered on the central axis 45 of the body (see FIG. 5). In the present example, the coring bit 50 and the coring bit recess 56 are rectangular (here square), although other shapes may also be used. Use of a coring bit recess 56 configuration advantageously allows different sizes/shapes of coring bits to be interchanged in the body 40 for different applications. For example, one bit style may be for corrugated cables 31a, while another bit style may be for smooth wall cables 31b, and different bit sizes may be used for cables of different conductor diameters, as will be appreciated by those skilled in the art. A set screw 60 may also be inserted through a threaded hole in the body 40 to contact the coring bit 50 and hold it securely in place, although this need not be used in all embodiments.

In some embodiments the first end 42 and depth of the coring bit recess 56 may be configured such that an edge or other indicator on the body 40 is aligned with either a marking on the cable 31 or on the back nut when the proper coring depth has been achieved. That is, the technician will turn the body 40 until the edge/indicator on the body is in alignment with the edge/indicator on the cable/back nut, indicating that the coring/flaring operation is complete. However, such a configuration need not be used in all embodiments.

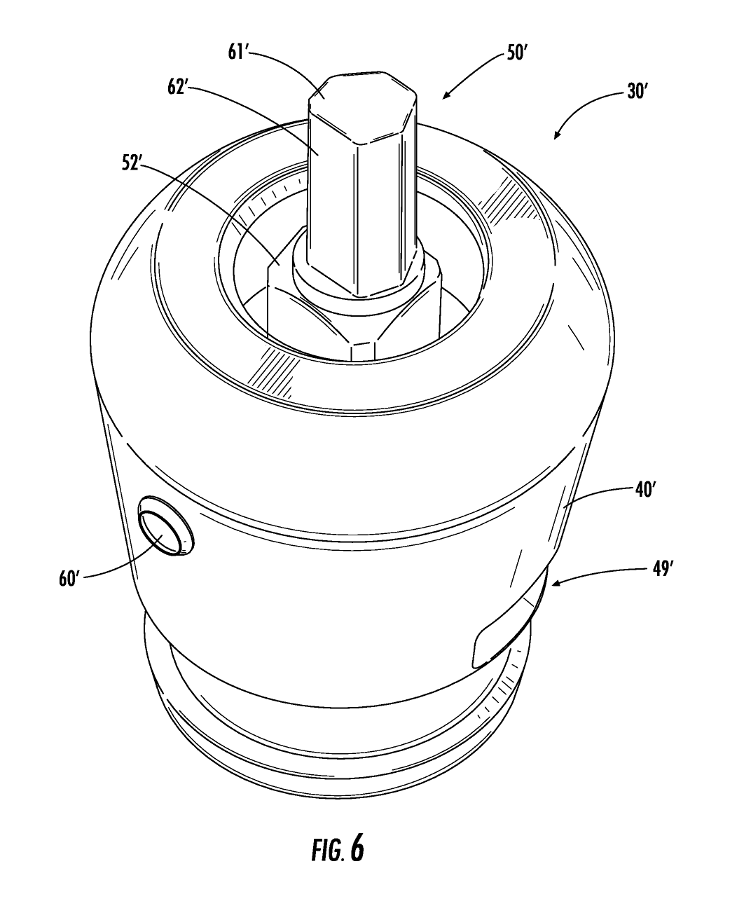

Turning now to FIGS. 6-8, an alternative embodiment of the cable end preparation tool 30′ is advantageously suited for use with a power driver, such as a cordless drill, for example. In this regard, the tool 30′ illustratively includes a coring bit 50′ including a cutting head 52′ and a drive shaft 61′ extending outwardly therefrom. More particularly, the cutting head 52′ when positioned in the coring bit recess 56′ may advantageously be used to rotate the body 40′ based upon rotation of the drive shaft 61′. In the illustrated embodiment, the drive shaft or shank 61′ has a plurality of flat sections or flats 62′ thereon, which in this example is three flats to define a triangular shank. This allows the drive shaft to be securely fastened within the chuck of a cordless drill, for example, as will be appreciated by those skilled in the art. However, other types of shanks may also be used, such as brace shanks, straight shanks, and hex shanks, for example, as will also be appreciated by those skilled in the art.

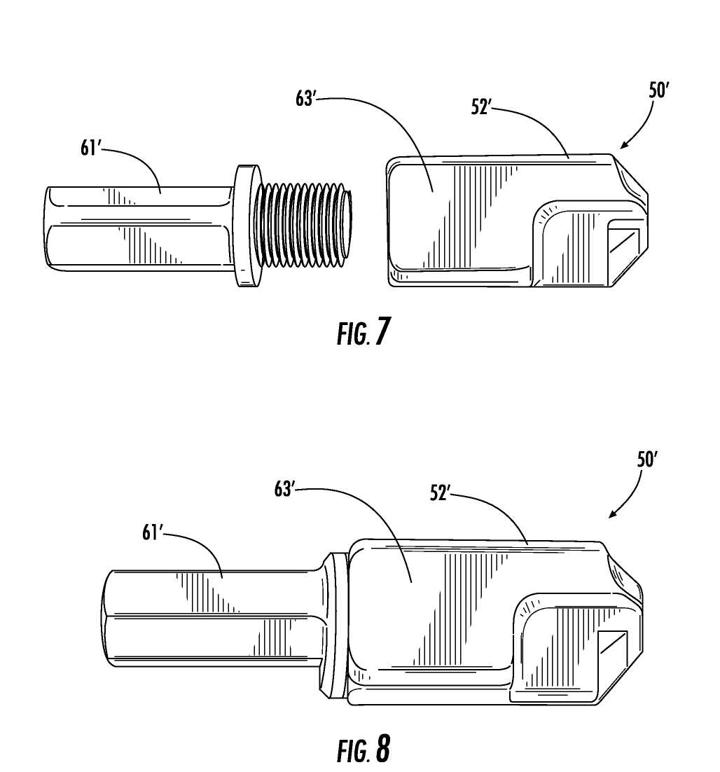

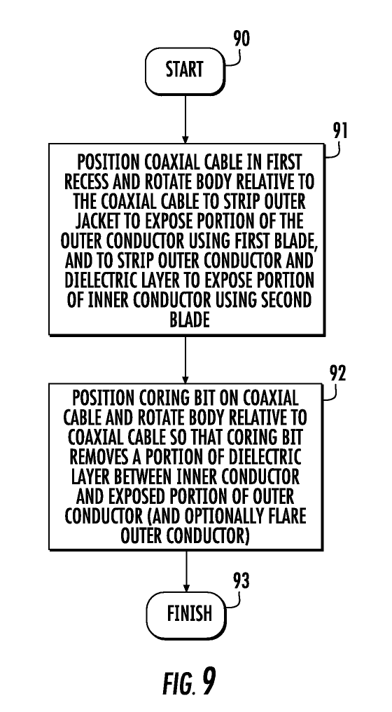

When the coring bit 50′ is removed or taken out of the coring bit recess 56′, the cutting head 52′ may then be used for removing the dielectric layer 33 between the inner conductor 32 and the exposed portion of the outer conductor 34 based upon rotation of the drive shaft 61′. That is, with the drive shaft 61′ still in the drill chuck, the cutting head 52 is removed from the body 40′ and the central opening 55′ therein is positioned on the exposed portion of the inner conductor 32 as an alignment guide for dielectric removal/flaring, as discussed above. The drive shaft 61′ and the cutting head 52′ may be threadably connected, as shown in FIGS. 7 and 8, although in some embodiments they may be made as a unitary piece, or may otherwise be connected (e.g., by a recess in the cutting head 52′ that slidably engages the drive shaft 61′, etc.).

As such, it will be appreciated that different coring bits 50′ (or cutting heads 52′) may also advantageously be interchangeably used for different cable types/sizes. To this end, it may also be advantageous to include marking indicia 63′ on the cutting heads 52′ to identify the respective types/sizes of coaxial cable 31 they are intended to be used with. In the illustrated example, the marking indicia on the cutting head 52′ is “LDF4.” As shown in the embodiment of FIG. 1, an indicia reading opening 64 may also advantageously be included in the body 40 that is aligned with the marking indicia 63 when the cutting head 52 is inserted in the coring bit recess 56, which allows the user to see which bit is in the body without the need to loosen the set screw 60 to remove the cutting head to view the marking indicia. This feature may be used with both the handheld tool embodiment 30 and the power tool embodiment 30′.

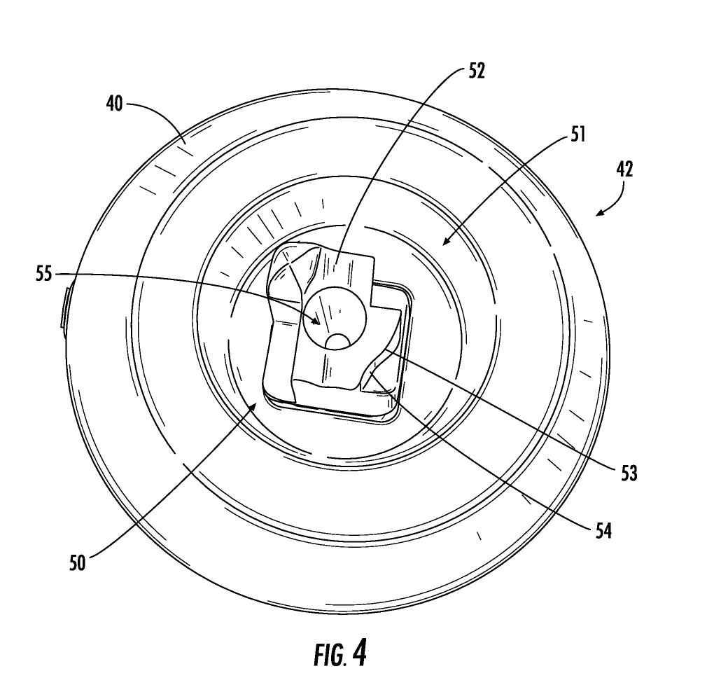

It will also be appreciated that with a removable drive shaft 61′, the coring bit 50′ may advantageously be used with a same body 40 as either a handheld tool (i.e., without the drive shaft) or as a power driven tool (i.e., with the drive shaft attached and connected to a drill chuck). Moreover, even with a unitary coring bit where the drive shaft 61′ is not removable from the cutting head 52′, an additional recess or hole may be used so that the coring bit 50′ can be inserted “backwards” (i.e., drive shaft first), and thereby still used as a hand tool without a drill. That is, the drive shaft recess would have a smaller diameter than the coring bit recess 56′ and would extend deeper into the body 40′ so that the drive shaft 61′ extends into the first recess 43′, leaving the cutting head positioned in the coring bit recess as shown in FIG. 4.

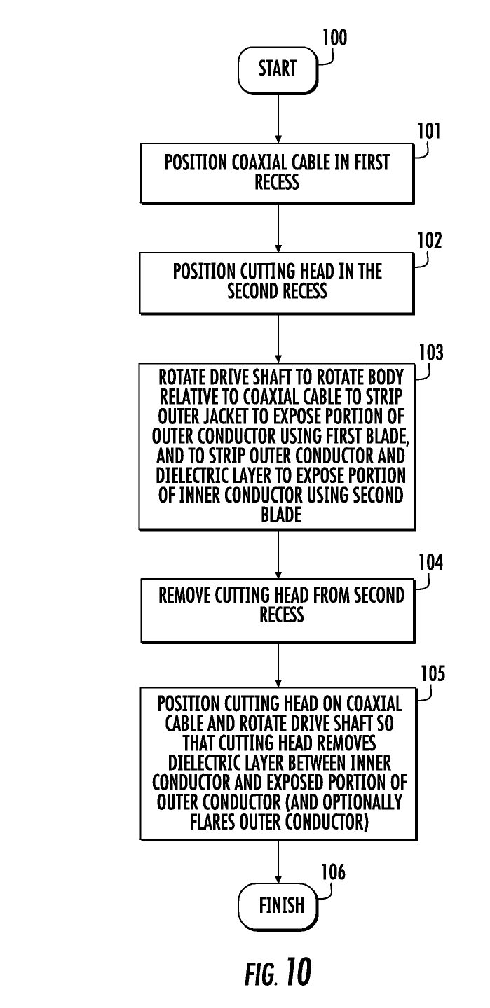

Referring now to FIG. 9, a cable end preparation method using the cable end preparation tool 30 begins (Block 90) with positioning the coaxial cable 31 in the first recess 43 and rotating the body 40 relative to the coaxial cable to strip the outer jacket 35 to expose a portion of the outer conductor 34 using the first blade 44, and to strip the outer conductor and dielectric layer 33 to expose a portion of the inner conductor 32 using the second blade 46, at Block 91. The back nut may be positioned on the stripped cable 31 at this time, as discussed above. The method further illustratively includes positioning the coring bit 50 on the coaxial cable 31 and rotating the body 40 relative to the coaxial cable so that the coring bit removes a portion of the dielectric layer 33 between the inner conductor 32 and the exposed portion of the outer conductor 34 (Block 92), and optionally flares the outer conductor, as discussed above, thus concluding the illustrated method (Block 93).

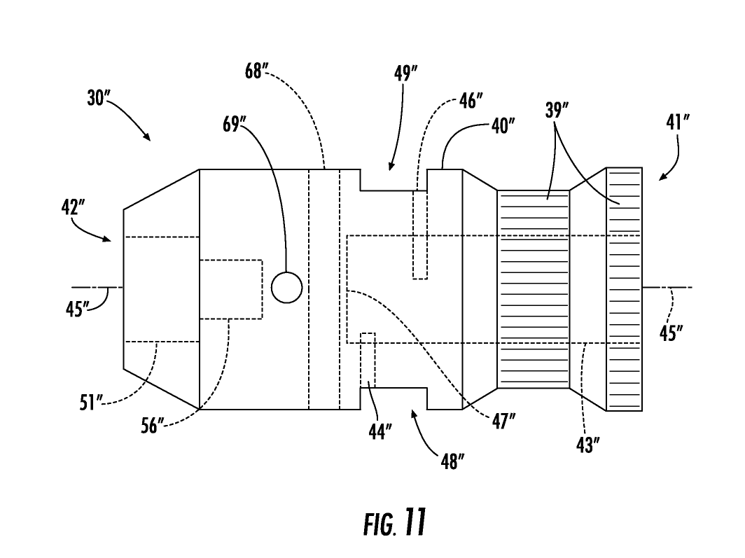

Turning additionally to FIG. 10, a related method for using the cable end preparation tool 30′ begins at Block 100 with positioning the coaxial cable 31 in the first recess 43′, and positioning the cutting head 52′ in the coring bit recess 56′, at Blocks 101-102 (although positioning of the cutting head could be performed earlier or later). The method further illustratively includes rotating the drive shaft 61′ to rotate the body 40′ relative to the coaxial cable 31 to strip the outer jacket 35 to expose a portion of the outer conductor 34 using the first blade 44, and to strip the outer conductor and dielectric layer 33 to expose a portion of the inner conductor 32 using the second blade 46, at Block 103. Here again, the back nut may be positioned on the stripped cable 31 at this time. In addition, the cutting head 52′ may be removed from the coring bit recess 56′ and positioned on the coaxial cable 31, and the drive shaft 61′ rotated so that the cutting head removes the dielectric layer 33 between the inner conductor 32 and the exposed portion of the outer conductor 34 (Blocks 104-105), and optionally flares the outer conductor, as discussed further above, thus concluding the illustrated method (Block 106).

Referring additionally to FIG. 11, another embodiment of the cable end preparation tool 30″ illustratively includes first and second holes 68″, 69″ positioned between the coring bit recess 56″ and first recess 43″, which advantageously may be used to apply leverage by the technician for rotation of the body 40″. That is, the technician may insert one or more levers, such as screw drivers, for exampler through the holes 68″, 69″ to provide handles and a greater turning radius for rotating the body 40″ and, thus, better leverage, as will be appreciated by those skilled in the art. In the illustrated example, the first and second holes 68″, 69″ are perpendicular to one another and pass through the entire body 40″. The first and second holes 68″, 69″ are also perpendicular to the longitudinal center axis 45″ of the body 40″. However, other numbers of holes (e.g., a single hole) may be used in some embodiments, and the holes need not pass all the way through the body 40″ as shown in all embodiments. This feature may be particularly useful for handheld versions of the tool 30″ in relatively large sizes, e.g., such as for 1¼ inch and 1⅝ inch sizes, where more force may be required by the technician to turn the body, although it may be used with power driven versions of the tool and different sizes of the tool as well.

This application is related to co-pending patent application entitled COAXIAL CABLE END PREPARATION TOOL WITH DRIVE SHAFT AND RELATED METHODS, attorney docket no. 63256, the disclosure of which is hereby incorporated herein in its entirety by reference.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A cable end preparation tool for a coaxial cable comprising an inner conductor, a dielectric layer surrounding the inner conductor, an outer conductor surrounding the dielectric layer, and an outer jacket surrounding the outer conductor, the cable end preparation tool comprising:
a body having first and second opposing ends with a first recess in the first end thereof;
a first blade carried by said body and extending within the first recess for stripping the outer jacket to expose a portion of the outer conductor when said body is rotated relative to the coaxial cable;
a second blade carried by said body and also extending within the first recess for stripping the outer conductor and dielectric layer to expose a portion of the inner conductor when said body is rotated relative to the coaxial cable; and
a coring bit carried by the second end of said body for removing a portion of the dielectric layer between the inner conductor and the exposed portion of the outer conductor when said body is rotated relative to the coaxial cable.

2. The cable end preparation tool of claim 1 wherein said coring bit has a predetermined shape for flaring the exposed portion of the outer conductor when said body is rotated relative to the coaxial cable.

3. The cable end preparation tool of claim 1 wherein said coring bit comprises a cutting head with a central opening therein for receiving the exposed inner conductor.

4. The cable end preparation tool of claim 1 wherein said body further has a coring bit recess therein for receiving said coring bit.

5. The cable end preparation tool of claim 4 wherein said coring bit and the coring bit recess are rectangular.

6. The cable end preparation tool of claim 4 wherein said body has a second recess in the second end thereof; and wherein said coring bit recess is within the second recess.

7. The cable end preparation tool of claim 1 wherein said coring bit has marking indicia thereon; and wherein said body has an indicia reading opening therein aligned with the marking indicia.

8. The cable end preparation tool of claim 1 wherein said first and second blades are removably mounted to said body.

9. The cable end preparation tool of claim 1 wherein said body has a plurality of surface gripping features on an external surface thereof.

10. The cable end preparation tool of claim 1 wherein said body has a cylindrical shape.

11. The cable end preparation tool of claim 1 wherein said body comprises plastic.

12. The cable end preparation tool of claim 1 wherein said body has a longitudinal center axis, and at least one hole therethrough perpendicular to the longitudinal center axis.

13. The cable end preparation tool of claim 1 wherein said body has a visual indicator on an exterior surface thereof corresponding to a longitudinal spacing between said first and second blades.

14. A cable end preparation tool for a coaxial cable comprising an inner conductor, a dielectric layer surrounding the inner conductor, an outer conductor surrounding the dielectric layer, and an outer jacket surrounding the outer conductor, the cable end preparation tool comprising:
a body having first and second opposing ends with a first recess in the first end thereof;
a first blade carried by said body and extending within the first recess for stripping the outer jacket to expose a portion of the outer conductor when said body is rotated relative to the coaxial cable;
a second blade carried by said body and also extending within the first recess for stripping the outer conductor and dielectric layer to expose a portion of the inner conductor when said body is rotated relative to the coaxial cable; and
a coring bit carried by the second end of said body for removing a portion of the dielectric layer between the inner conductor and the exposed portion of the outer conductor when said body is rotated relative to the coaxial cable;
said coring bit comprising a cutting head with a central opening therein for receiving the exposed inner conductor, and said cutting head having a predetermined shape for flaring the exposed portion of the outer conductor when said body is rotated relative to the coaxial cable.

15. The cable end preparation tool of claim 14 wherein said body further has a coring bit recess therein for receiving said coring bit.

16. The cable end preparation tool of claim 15 wherein said coring bit and the coring bit recess are rectangular.

17. The cable end preparation tool of claim 14 wherein said coring bit has marking indicia thereon; and wherein said body has an indicia reading opening therein aligned with the marking indicia.

18. A cable end preparation method for a coaxial cable comprising an inner conductor, a dielectric layer surrounding the inner conductor, an outer conductor surrounding the dielectric layer, and an outer jacket surrounding the outer conductor, the method comprising:
providing a cable end preparation tool comprising a body having first and second opposing ends with a first recess in the first end thereof, first and second blades carried by the body and extending within the first recess, and a coring bit carried by the second end of the body;
positioning the coaxial cable in the first recess and rotating the body relative to the coaxial cable to strip the outer jacket to expose a portion of the outer conductor using the first blade, and to strip the outer conductor and dielectric layer to expose a portion of the inner conductor using the second blade; and
positioning the coring bit on the coaxial cable and rotating the body relative to the coaxial cable so that the coring bit removes a portion of the dielectric layer between the inner conductor and the exposed portion of the outer conductor.

19. The method of claim 18 wherein the coring bit has a predetermined shape for flaring the exposed portion of the outer conductor when the body is rotated relative to the coaxial cable.

20. The method of claim 18 wherein the coring bit comprises a cutting head with a central opening therein; and wherein positioning the coring bit comprises positioning the central opening to receive the exposed inner conductor.

21. The method of claim 18 wherein the body further has a coring bit recess therein for receiving the coring bit.

22. The method of claim 18 wherein the coring bit has marking indicia thereon; and wherein the body has an indicia reading opening therein aligned with the marking indicia.
